(19) United States
(12) Patent Application Publication
(10) Pub. No.: US 2016/0294484 A1
(43) Pub. Date: Oct. 6, 2016

(54) EMBEDDING CODES IN AN AUDIO SIGNAL

(71) Applicant: QUALCOMM TECHNOLOGIES INTERNATIONAL, LTD., Cambridge (GB)

(72) Inventors: Paul HISCOCK, Cambridge (GB); David RIMMER, Cambridge (GB)

(21) Appl. No.: 14/674,919

(22) Filed: Mar. 31, 2015

(51) Int. Cl. H04B 11/00

(52) U.S. Cl. CPC H04B 11/00

(57) ABSTRACT

A method of communicating data imperceptibly in an audio signal. The method comprises, for each sub-band of the audio signal, identifying the tone in that sub-band having the highest amplitude. An audio code comprising the data to be communicated is scaled by a frequency mask profile, the frequency mask profile having maxima at the frequencies of the identified tones. The audio signal and the scaled audio code are aggregated to form a composite audio signal. The composite audio signal is then transmitted.

This invention relates to imperceptibly embedding an audio code within an audio signal.

### BACKGROUND

It is known to use ultrasound for detection and ranging applications. Generally, an ultrasound signal is transmitted by a transducer. The ultrasound signal reflects off nearby objects, and a portion of the reflected signal propagates back towards the transducer, where it is detected. The difference in time between the transducer transmitting the ultrasound signal and receiving the reflected ultrasound signal is the round-trip time of that signal. Half the round-trip time multiplied by the speed of ultrasound in the medium in question gives the distance from the transducer to the detected object.

Ultrasound has several properties which make it useful for many practical applications. Ultrasound used at typical levels is not damaging radiation to humans, thus can be used around people. No physical contact with the target object is required. This is useful where the target object is fragile or not directly accessible. Ultrasound is outside of the human hearing range, thus it is not directly perceivable by people. This is useful where the fact that ultrasound is used is not intended to be communicated to the user, for example where ultrasound is used to detect approaching people in order to trigger a door to automatically open.

Using ultrasound for determining the location of objects in a room has cm accuracy. However, ultrasound waves decay very quickly, so are not suitable for use in determining the locations of objects in large spaces. Additionally, a transducer is required to generate the ultrasound signal. Transducers are relatively expensive. Because of this they are generally only available in specialist ultrasonic equipment. Transducers are not incorporated into consumer mobile devices such as mobile phones and tablets.

Thus, there is a need for an alternative technique to utilising ultrasound which can be used to determine the location of objects in larger spaces, which can be implemented with typical consumer mobile devices but which retains the advantages of ultrasound of not being directly perceivable by humans, not requiring any physical contact to be made, and being safe for use around people.

### SUMMARY OF THE INVENTION

According to a first aspect, there is provided a method of communicating data imperceptibly in an audio signal, the method comprising: for each sub-band of the audio signal, identifying the tone in that sub-band having the highest amplitude; scaling an audio code comprising the data to be communicated by a frequency mask profile, the frequency mask profile having maxima at the frequencies of the identified tones; aggregating the audio signal and the scaled audio code to form a composite audio signal; and transmitting the composite audio signal.

Suitably, the sub-bands are frequency Barks.

In one example, within each sub-band, the frequency mask profile decays from the maximum towards the lower frequency bound of the sub-band at a first predetermined rate, the first predetermined rate being such that the frequency mask profile is imperceptible to human hearing exposed simultaneously to the audio signal and the frequency mask profile. The first predetermined rate may be 25 dB/Bark. Within each sub-band, the frequency mask profile decays from the maximum towards the higher frequency bound of the sub-band at a second predetermined rate, the second predetermined rate being such that the frequency mask profile is imperceptible to human hearing exposed simultaneously to the audio signal and the frequency mask profile. The second predetermined rate may be 10 dB/Bark.

Suitably, the maxima of the frequency mask profile matches the amplitudes of the corresponding identified tones, and the method comprises scaling the audio code by: reducing the amplitude of the frequency mask profile by an offset to form a reduced amplitude frequency mask profile, and multiplying the audio code by the reduced amplitude frequency mask profile.

Alternatively, the maxima of the frequency mask profile have amplitudes reduced from the corresponding identified tones by an offset, and the method comprises scaling the audio code by multiplying the audio code by the amplitude frequency mask profile.

The method may further comprise for a subsequent frame of the audio signal, scaling a further audio code by the frequency mask profile by: reducing the amplitude of the frequency mask profile by a further offset to form a further reduced amplitude frequency mask profile; and multiplying the further audio code by the further reduced amplitude frequency mask profile.

The method may further comprise for a subsequent frame of the audio signal: reducing the amplitude of the frequency mask profile by a further offset to form a further reduced amplitude frequency mask profile; for each sub-band of the subsequent frame of the audio signal, identifying the further tone in that sub-band having the highest amplitude; for each sub-band, if the further identified tone has a lower amplitude than the maximum in that sub-band of the further reduced amplitude frequency mask profile, scaling a further audio code by the frequency mask profile, and if the further identified tone has a higher amplitude than the maximum in that sub-band of the further reduced amplitude frequency mask profile, scaling the further audio code by a further frequency mask profile, the further frequency mask profile having a maximum in that sub-band at the frequency of the further identified tone.

The method may further comprise embedding the audio code in each of several frames of the audio signal.

According to a first aspect, there is provided a communications device for communicating data imperceptibly in an audio signal, the communications device comprising: a processor configured to: for each sub-band of the audio signal, identify the tone in that sub-band having the highest amplitude; scale an audio code comprising the data to be communicated by a frequency mask profile, the frequency mask profile having maxima at the frequencies of the identified tones; and aggregate the audio signal and the scaled audio code to form a composite audio signal; and a transmitter configured to transmit the composite audio signal.

### BRIEF DESCRIPTION OF THE DRAWINGS

The present invention will now be described by way of example with reference to the accompanying drawings. In the drawings:

FIG. 1 illustrates a frequency spectrum of an audio signal, a frequency mask profile, and an embedded audio code;

FIG. 2 illustrates a method of communicating data imperceptibly in an audio signal;

FIG. 3 illustrates a frequency spectrum of an audio signal, a frequency mask profile, and an embedded audio code;

FIG. 4 illustrates an averaged correlation response;

FIG. 5 illustrates an unsymmetrical speaker system;

FIG. 6 illustrates a method of determining the locations of speakers in a speaker system;

FIG. 7 illustrates a method of calibrating a speaker system; and

FIG. 8 illustrates an exemplary transmitter.

### DETAILED DESCRIPTION

The following description is presented to enable any person skilled in the art to make and use the invention, and is provided in the context of a particular application. Various modifications to the disclosed embodiments will be readily apparent to those skilled in the art. The general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The following describes wireless communication devices for transmitting data and receiving that data. That data is described herein as being transmitted in packets and/or frames and/or messages. This terminology is used for convenience and ease of description. Packets, frames and messages have different formats in different communications protocols. Some communications protocols use different terminology. Thus, it will be understood that the terms “packet” and “frame” and “messages” are used herein to denote any signal, data or message transmitted over the network.

Psychoacoustic experiments have been conducted on people to assess how one sound is perceived when another louder sound is concurrently being heard. The results of these experiments show that in the presence of a first sound, human hearing is desensitised to quieter sounds that are proximal in frequency to the first sound. The results of these experiments also show that when the first sound stops, human hearing is temporarily desensitised to other sounds proximal in frequency to the first sound. Furthermore, the experiments also show that human hearing is less sensitive to sounds above 10 kHz and most adults are insensitive to sounds above 16 kHz.

The methods described herein utilise the desensitisation of human hearing to particular otherwise-audible sounds in the presence of other sounds, in order to transmit audio data in an audio signal such that that audio data is not perceived by humans listening to the audio signal, but is nevertheless detectable by an audio microphone.

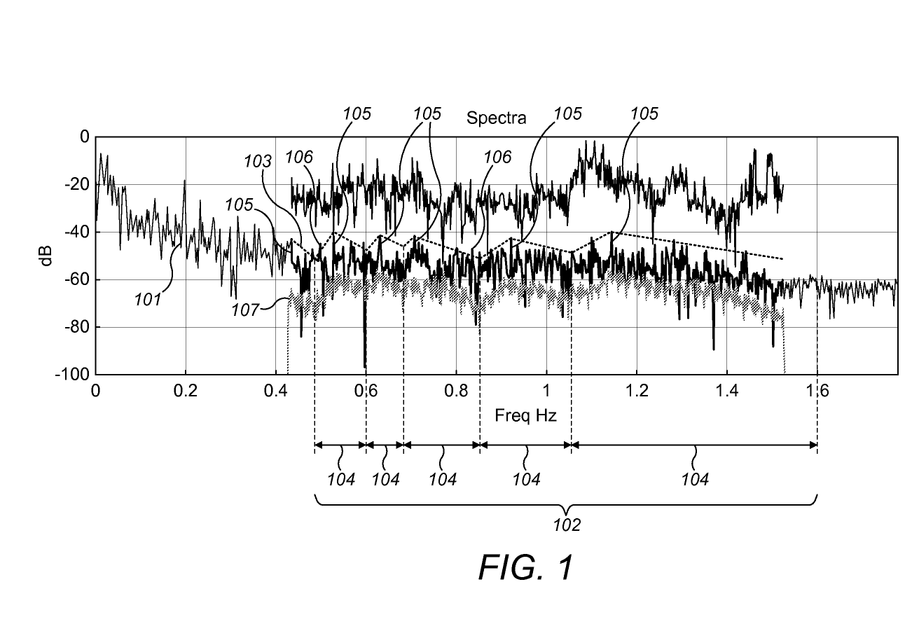

FIG. 1 illustrates the frequency-vs-amplitude spectrum of an audio signal 101. FIG. 1 illustrates a frequency mask profile 103 in a frequency range 102 of audio signal 101. The frequency mask profile 103 is generated as follows. Firstly, the frequency range 102 is split up into a plurality of frequency sub-bands 104. Suitably, adjacent sub-bands 104 are approximately logarithmic in bandwidth. For example, the sub-bands 104 may be Barks. The Bark frequency scale ranges from 1 to 24 Barks and corresponds to the first 24 bands of human hearing. Secondly, within each sub-band, the frequency tone of signal 101 having the highest amplitude is determined. In other words, the frequency characteristic having the highest amplitude is determined. These tones are marked 105 on FIG. 1. As discussed above, human hearing is desensitised to sounds proximal in frequency to these tones. Psychoacoustic experiments have shown that human hearing's ability to detect sounds proximal to the identified tone decays at a rate of 25 dB/Bark for frequencies before the frequency of the tone, and decays at a rate of 10 dB/Bark for frequencies after the frequency of the tone. Thus, the frequency mask profile drops off at a rate of 25 dB/Bark before the frequency of each tone, and at a rate of 10 dB/Bark after each tone. Thus, the frequency mask profile 103 represents the relative change in sensitivity against frequency in response to the tones 105. Near to the peak tone frequencies more sound energy can be added without it being perceived by humans. Away from the peaks less energy can be added.

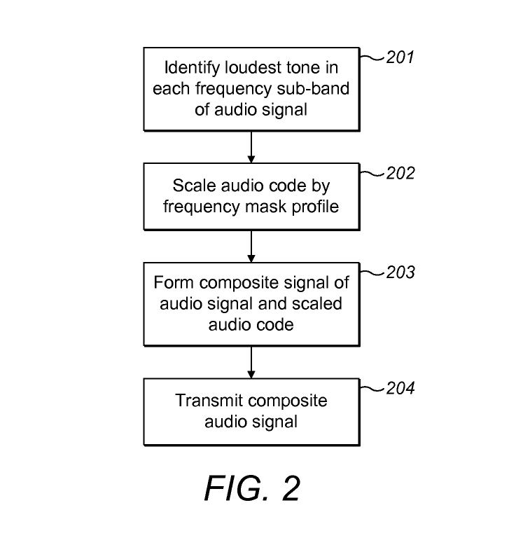

FIG. 2 is a flowchart illustrating a method of communicating data imperceptibly in an audio signal. That data is comprised within an audio code to be embedded in the audio signal. Suitably, that audio code lies within the human hearing range. In other words, that audio code is capable of being heard by humans. As described above, the audio signal 101 is split up into frequency sub-bands. At step 201, for each sub-band, the loudest frequency tone 105 is identified. In other words, the frequency characteristic having the highest amplitude is identified. At step 202, the audio code to be embedded is scaled by a frequency mask profile. At step 203, a composite signal is formed by aggregating the audio signal and the scaled

audio code. At step 204, the composite audio signal is transmitted.

The audio code to be embedded is scaled by a frequency mask profile such that when incorporated into the audio signal to form the composite signal, the audio code is not perceptible by humans listening to the composite signal. In this example, it is assumed that the spectrum of the audio code to be added is flat in region 102.

The frequency mask profile has maxima at the frequencies of the tones identified in step 201 of FIG. 2. Within each sub-band, the frequency mask profile decays from the maximum towards the lower frequency bound of the sub-band at a predetermined rate. That predetermined rate is such that the frequency mask profile is imperceptible to human hearing exposed simultaneously to the audio signal and the frequency mask profile. Suitably, that predetermined rate is 25 dB/Bark, as discussed above. Within each sub-band, the frequency mask profile decays from the maximum towards the higher frequency bound of the sub-band at a predetermined rate. That predetermined rate is such that the frequency mask profile is imperceptible to human hearing exposed simultaneously to the audio signal and the frequency mask profile. Suitably, that predetermined rate is 10 dB/Bark, as discussed above.

The frequency mask profile may be as shown in FIG. 1. In this implementation, the amplitudes of the maxima of the frequency mask profile match the amplitudes of the corresponding tones identified in step 201 of FIG. 2. In this implementation, the audio code is scaled by the frequency mask profile at step 202 as follows. Firstly, the amplitude of the frequency mask profile is reduced by an offset. Suitably, that offset is predetermined. The offset may be determined experimentally. The offset may be device-dependent. The offset may be dependent on the type of audio content of the audio signal 101. The offset may be user-dependent. For example, the offset may be dependent on a user profile, which may take into account parameters such as age of the user. Suitably, the offset is determined using subjective techniques that aim to balance the strength and quality of the detected code against the perceived annoyance of hearing the code in the wanted audio signal 101.

The audio code to be embedded is then multiplied by the reduced amplitude frequency mask profile. The scaled audio code is marked as 107 on FIG. 1. This scaled audio code can be seen to follow the general contours of the frequency mask profile, but reduced in amplitude. Thus, in the frequency range 102, the composite signal is formed of the scaled audio code 107 and the audio signal 101 in the frequency range 102. The scaled audio code occupies a region of the spectrum that human hearing is desensitised to as described above, thus a human listening to the composite signal hears the audio signal 101 but does not perceive the scaled audio code 107.

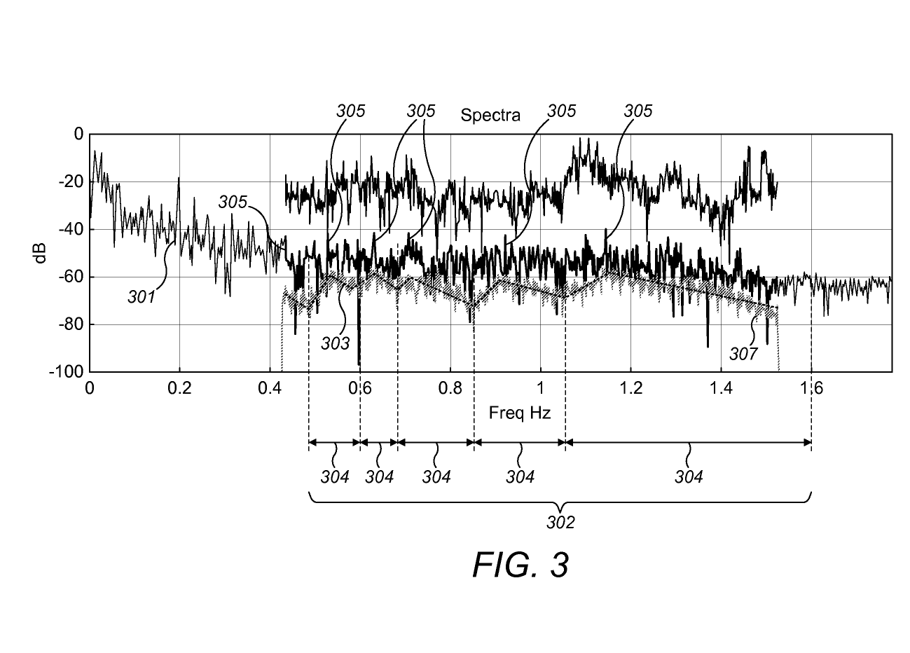

The frequency mask profile may be as shown in FIG. 3. In this implementation, the amplitudes of the maxima of the frequency mask profile 303 do not match the amplitudes of the corresponding tones 305 identified in step 201 of FIG. 2. The amplitudes of the maxima of the frequency mask profile are reduced from the amplitudes of the corresponding tones by an offset. Suitably, this offset is predetermined. The offset may-be determined as described in the previous paragraph. The audio code is scaled by the frequency mask profile at step 202 by multiplying the audio code by the frequency mask profile. The scaled audio code is marked as 307 on FIG. 3. This scaled audio code follows the general contours of the frequency mask profile. As in FIG. 1, in the frequency range marked 302, the composite signal is formed of the scaled audio code 307 and the audio signal 301 in the frequency range 302. The scaled audio code occupies a region of the spectrum that human hearing is desensitised to as described above, thus a human listening to the composite signal hears the audio signal 301 but does not perceive the scaled audio code 307.

For the same audio code and audio signal, the scaled audio code of FIG. 1 is the same as the scaled audio code of FIG. 3.

Psychoacoustic experiments have shown that after a sound has stopped, humans are temporarily desensitised to other sounds proximal to the frequency of the stopped sound. Thus, in an exemplary implementation, the loudest frequency tones of prior time frames of the audio signal are taken into account when scaling audio codes of subsequent time frames of the audio signal. The frequency mask profile used to scale the audio code of the nth frame of the audio signal is reduced in amplitude by an offset for use in the n+1th frame of the audio signal. Suitably, that offset is predetermined. The offset may be determined experimentally. This offset accounts for the degree to which human hearing has re-sensitised since the loudest frequency tone stopped. In other words, the reduction in amplitude for use in the n+1th frame matches the amount by which human hearing has re-sensitised to the frequencies proximal to the loudest frequency tones of the audio signal of the nth frame since the time of the nth frame. For each sub-band of the n+1th frame, the loudest frequency tone is identified. The amplitude of that loudest frequency tone is determined. For each sub-band, the amplitude of the loudest frequency tone is compared to the amplitude of the maximum of the reduced frequency mask profile from the nth frame. If the amplitude of the maximum of the reduced frequency mask profile is greater than the amplitude of the loudest frequency tone, then the reduced frequency mask profile is used to scale the audio code to be embedded into the audio signal for that sub-band as described above. If, on the other hand, the amplitude of the loudest frequency tone is greater than the amplitude of the maximum of the reduced frequency mask profile, then the audio code to be embedded into the audio signal is scaled by a further frequency mask profile for that sub-band. This further frequency mask profile has a maximum at the frequency of the loudest tone in that sub-band of the n+1th frame of the audio signal. The further frequency mask profile decays from this maximum towards the higher frequency bound of the sub-band at a predetermined rate as previously described. The further frequency mask profile decays from this maximum towards the lower frequency bound of the sub-band at a predetermined rate as previously described.

This method described with respect to the n+1th frame applies iteratively to subsequent frames of the audio signal.

In order to reduce processing power, audio codes of a plurality of adjacent frames of the audio signal may be scaled by the same frequency mask profile. This frequency mask profile may be reduced in amplitude over time as described above. In this case, identifying the loudest tones in the sub-bands of the audio signal at step 201 of FIG. 2 is not implemented for those frames. This is not as effective as the methods described above, but is a lower power implementation. The smoother the frequency-amplitude profile of the audio signal, the more effective this is.

The audio code to be embedded may be of any suitable form. Suitably, the audio code is capable of being successfully auto-correlated. For example, the audio code may comprise an M-sequence. Alternatively, the audio code may comprise a Gold code. Alternatively, the audio code may comprise one or more chirps. Chirps are signals which have a frequency which increases or decreases with time. The start and end frequencies of the audio code may be selected in dependence on the spectral response of the device which is intended to receive the audio signal. For example, if a microphone is intended to receive the audio signal, then the start and end frequencies of the audio code are selected to be within the operating bandwidth of the microphone.

Suitably, the embedded audio code is a code which is known to the receiver. For example, an embedded audio code may be a device identifier which is known to the receiver. Suitably, the set of audio codes which may be embedded in an audio signal are orthogonal to each other. The receiver stores replica codes. These replica codes are replicas of the audio codes which may be embedded in the audio signal. The receiver determines which audio code is embedded in an audio signal by correlating the received audio signal with the replica codes. Since the audio codes are orthogonal to each other, the received audio signal correlates strongly with one of the replica codes and weakly with the other replica codes. If the receiver is not initially time aligned to the received audio signal, then the receiver correlates the received signal against each replica code a plurality of times, each time adjusting the time alignment of the replica code and the received signal.

In the case that the audio code comprises chirps, the coded chirp may be selected to be a power-of-2 in length. In other words, the number of samples in the chirp is a power-of-2. This enables a power-of-2 FFT (fast fourier transform) algorithm to be used in the correlation without interpolating the chirp samples. For example, a Cooley-Tukey FFT can be used without interpolation. In contrast, M-sequences and Gold codes are not a power-of-2 in length and so interpolation is used in order to use a power-of-2 FFT algorithm in the correlation. This requires an additional processing step.

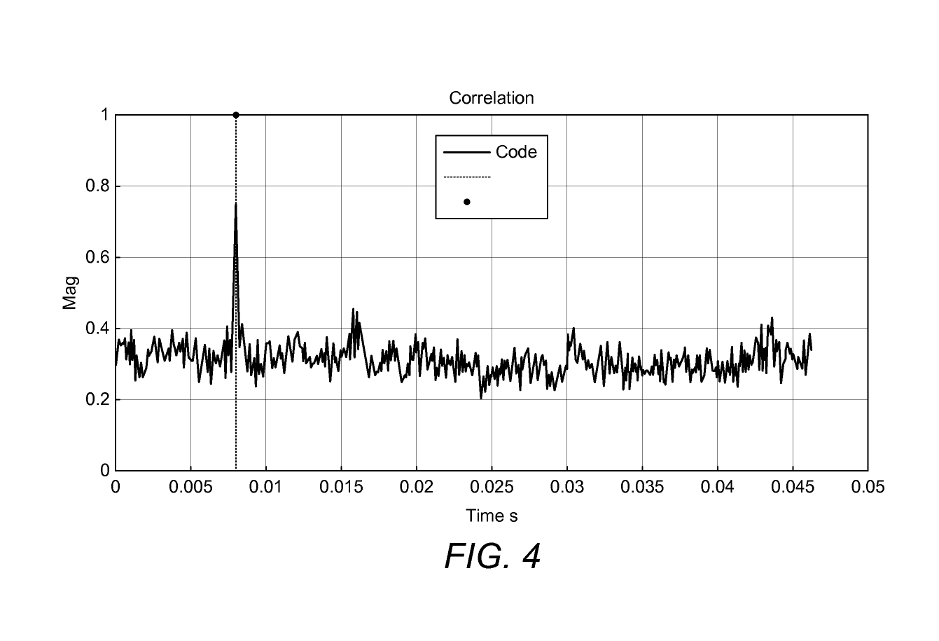

The chirp receiver is able to successfully correlate the received signal with the replica codes even though the audio code has been scaled by the frequency mask profile and the receiver does not know what the frequency mask profile is. In an exemplary implementation, the transmitter embeds the same audio code in a plurality of successive frames of the audio signal. The audio code may be subjected to different scaling in each of those frames. It is known to the receiver how many times the same audio code is being transmitted. The receiver performs correlations as described above against the replica codes. The receiver averages the correlator outputs over the set of correlations for the same audio code. FIG. 4 illustrates an averaged correlation output over 10 correlation outputs. The result provides increased sensitivity compared to individual correlator outputs. The correlation peak is readily identifiable above the background level.

The transmitter may determine that no audio signal is to be transmitted. For example, this may happen at step 201 of FIG. 2, in which no loudest tones are identified or they are identified to have no amplitude. In this case, the transmitter determines to embed the audio code to be transmitted in a flat audio signal at high frequency bands. For example, at frequency bands above 16 kHz. Thus, the transmitted composite signal is less perceivable to human hearing than a lower frequency signal. Even in the case that there is an audio signal to be transmitted, the transmitter may embed an audio code at high frequency bands. This may be alternatively to, or in addition to, embedding the audio code as described elsewhere herein.

By embedding an audio code in an audio signal in the manner described, the composite signal can be received and decoded by a normal audio microphone. In other words, no specialist equipment is needed. Microphones in everyday consumer mobile devices such as mobile phones and tablets are capable of receiving and processing the composite audio signals.

Embedding an audio code in an audio signal such that the audio code is imperceptible to human hearing as described herein has many applications. For example, the embedded audio codes may be used to locate and track objects or people. This is particularly applicable to locating and tracking targets inside, for example in a warehouse or shopping mall. In this case, the target would comprise a microphone. For example, the microphone may be comprised within a tag on an object or a mobile phone carried by a person. Location codes are embedded into audio signals transmitted from objects in the room.

The following describes the example of locating and tracking a person in a shopping mall. Speakers of the PA system in a shopping mall may transmit composite signals of the form described above. Each speaker embeds a location audio code into the audio signal it is transmitting. For example, the PA system may be transmitting media such as music or advertising or announcements to shoppers. The location audio codes are embedded into this audio signal. Each location audio code comprises data indicating the location of the speaker that transmitted the audio signal. Each speaker embeds the location audio code into the same segment of the audio signal and transmits the audio signal at the same time as the other speakers. Because the methods described herein are used, the shoppers do not perceive the location audio codes. The microphone of the mobile phone of a shopper receives the location audio codes from several speakers. Suitably, the mobile phone is configured to perform the correlation steps described above to decode the received audio signals. The mobile phone also time-stamps the time-of-arrival of the location audio codes at the mobile phone. The mobile phone is able to determine its location using the decoded locations of the speakers and the time-difference-of-arrival of the location audio codes from the speakers as received at the mobile phone. Thus, in this manner, the mobile phone is able to determine its location and hence track the position of the user carrying the mobile phone as they move around the shopping mall. In an alternative implementation, the mobile device may forward the received signal and the time-of-arrival of that received signal onto a location-determining device. The location-determining device then performs the processing steps described above. The same principle applies to locating and tracking any microphone device that is attached to a target to be located and tracked.

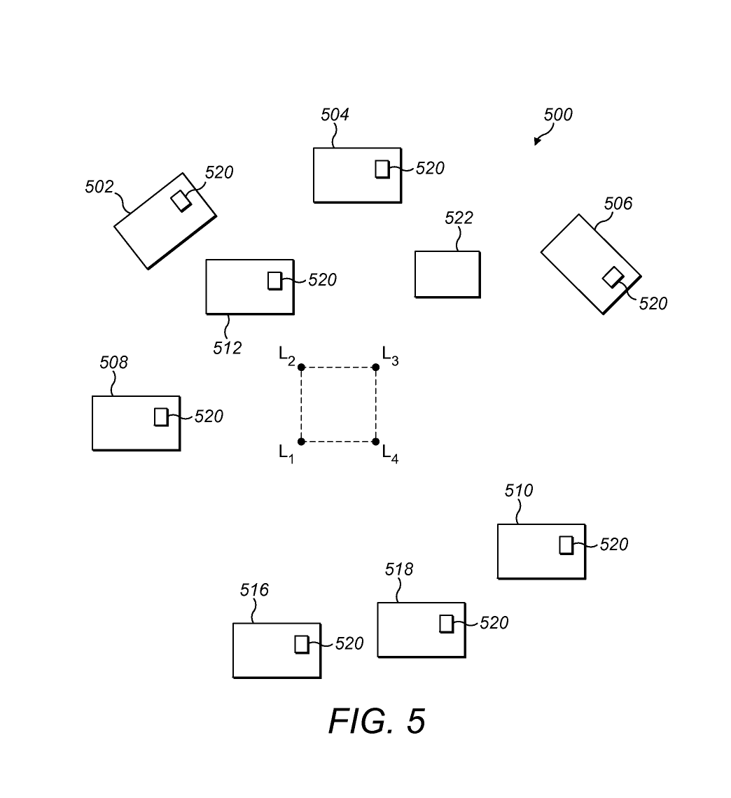

Embedding an audio code in an audio signal in an imperceptible way to human hearing may also be applied to speaker systems, for example speaker systems of a home entertainment system. FIG. 5 illustrates an example of a speaker system, in which the speakers are arranged in an unsymmetrical formation. Alternatively, the speakers may be arranged in a symmetrical 5.1 or 7.1 formation. The speaker system 500 comprises eight speakers 502, 504, 506, 508, 510, 512, 516 and 518. The speakers each comprise a wireless communications unit 520 that enables them to operate according to a wireless communications protocol, for example for receiving audio to play out. The speakers each also comprise a speaker unit for playing out audio. The speakers are all in line-of-sight of each other.

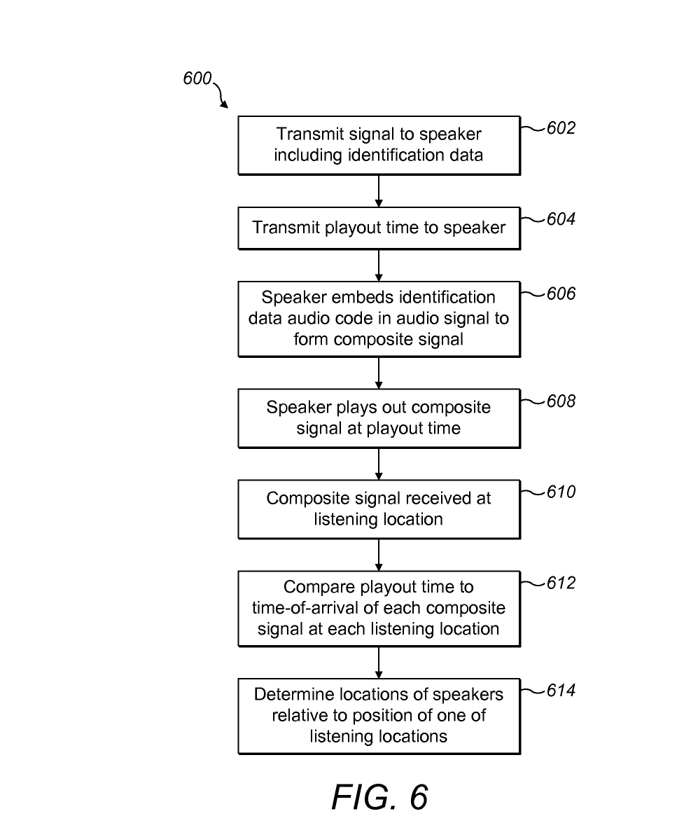

FIG. 6 is a flowchart illustrating a method of determining the location of speakers in a speaker system. This method applies to any speaker system. For convenience, the method is described with reference to the speaker system of FIG. 5. At step 602, a signal is transmitted to each speaker of the speaker system. This signal includes identification data for that speaker. At step 604, a signal is transmitted to each speaker of the speaker system which includes a playout time or data indicative of a playout time for playing out a composite audio signal including the identification data of the speaker. At step 606, the speaker embeds the identification data audio code in an audio signal to form a composite audio signal as described herein. At step 608, each speaker plays out its composite audio signal at the playout time identified from the signal in step 604. At step 610, the composite audio signal from each speaker is received at a microphone device at a listening location. At step 612, the playout time of a composite audio signal is compared to the time-of-arrival of that composite audio signal at the listening location, for each listening location that the composite audio signal is received at. At step 614, the locations of the speakers are determined relative to the position of one of the listening locations. There are at least three listening locations, and relative positional information about those at least three listening locations is known. This enables the locations of the speakers to be determined.

The speaker system of FIG. 5 may further include controller 522. Controller 522 may, for example, be located in a sound bar. Controller 522 may perform steps 602 and 604 of FIG. 6. The controller may transmit the signals of step 602 and/or 604 in response to the user initiating the location determination procedure by interacting with a user interface on the controller, for example by pressing a button on the controller. Alternatively, the controller may transmit the signals of step 602 and/or 604 in response to the user initiating the location determination procedure by interacting with the user interface on a mobile device. The mobile device then signals the controller 522 to transmit the signals of steps 602 and/or 604. The mobile device may communicate with the controller in accordance with a wireless communications protocol. For example, the mobile device may communicate with the controller using Bluetooth protocols. The controller may transmit the signals of steps 602 and 604 to the speakers over a wireless communications protocol. This may be the same or different to the wireless communications protocol used for communications between the controller and the mobile device.

Alternatively, a mobile device may perform steps 602 and 604 of FIG. 6. This mobile device may be the microphone device at one of the listening locations. The mobile device may transmit the signals of steps 602 and/or 604 in response to the user initiating the location determination procedure by interacting with a user interface of the mobile device. The mobile device may communicate with the speakers in accordance with a wireless communications protocol, such as Bluetooth.

The microphone device at a listening location receives the composite audio signals played out from each speaker in the speaker system. The microphone device may then relay the received composite audio signals onto a location-determining device. The location-determining device may be the controller 522. The location-determining device may be a mobile device, for example the user's mobile phone. Alternatively, the microphone device may extract data from the composite audio signals, and forward this data onto the location-determining device. This data may include, for example, the identification data of the composite audio signals, absolute or relative time-of-arrivals of the composite audio signals, absolute or relative amplitudes of the composite audio signals, and absolute or relative phases of the composite audio signals. The location-determining device receives the relayed or forwarded data from the microphone at each listening location.

For each listening location and speaker combination, the location-determining device compares the playout time of the composite audio signal from the speaker to the time-of-arrival of that composite audio signal at a microphone (step 612). The location-determining device determines the time lag between the time-of-arrival and the playout time for each listening location/speaker combination to be the time-of-arrival of the composite audio signal minus the playout time of that composite audio signal. The location-determining device determines the distance between the speaker and the listening location in each combination to be the time lag between those two devices multiplied by the speed of sound in air. The location-determining device then determines the locations of the speakers from this information using simultaneous equations (step 614).

Alternatively, the microphone device at a listening location may determine the distance to the transmitting speaker, as described above in respect of the location-determining device. The microphone device may then transmit the determined distance to the location-determining device. In this implementation, the playout time of the transmitting speaker and its identification data is initially transmitted to the microphone device. The microphone device stores the playout time and identification data of the speaker.

The speakers in the speaker system may simultaneously play out their composite audio signals. In this case, the microphone device receives the audio codes of the different speakers concurrently. The locations of the speakers are then determined from the time difference of arrival of the composite audio signals from the speakers at the microphone device.

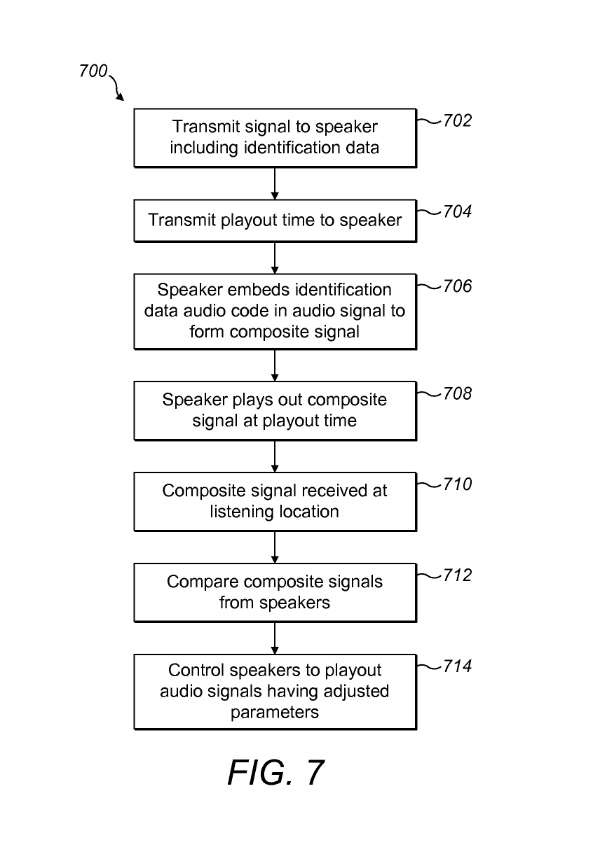

FIG. 7 is a flowchart illustrating a method of calibrating the audio signals played out from the speakers of FIG. 5 in order to align those audio signals at a particular listening location, for example L1. At step 702, a signal is transmitted to each speaker of the speaker system. This signal includes identification data for that speaker. At step 704, a signal is transmitted to each speaker of the speaker system which includes a playout time or data indicative of a playout time for playing out a composite audio signal including the identification data of the speaker. At step 706, the speaker embeds the identification data audio code into an audio signal to form a composite audio signal as described herein. At step 708, each speaker plays out its composite audio signal at the playout time identified from the signal in step 704. At step 710, the composite audio signal from each speaker is received at a microphone device at listening location L1. At step 712, the composite audio signals from the speakers of the speaker system as received at listening location L1 are compared. At step 714, the speakers are controlled to play out audio signals having adjusted parameters, the adjusted parameters having been determined based on the comparison of step 712 so as to align the played out audio signals at the listening location L1. Controller 522 or a mobile device at the listening location may perform steps 702 and 704 as described above with respect to FIG. 6.

The microphone device at the listening location L1 receives the composite audio signals played out from each speaker in the speaker system. As described above with respect to FIG. 6, the microphone device may be the comparison device which performs step 712 or it may relay data extracted from the composite audio signals to controller 522, in which case controller 522 is the comparison device which performs step 712. Once the comparison device has identified received data as originating from a specific speaker using the correlation methods described herein, it may compare the time-of-arrival of that received data at the listening location L1 against the stored playout time for that speaker. For each speaker, the comparison device determines a time lag which is the difference between the time-of-arrival of that speaker's composite audio signal at the listening location L1 and the playout time of the composite audio signal from the speaker. The comparison device may then compare the time lags of the speakers in the speaker system in order to determine whether the time lags are equal or not. If the time lags are not equal, then the comparison device determines to modify the time at which the speakers play out audio signals relative to each other so that audio signals from all the speakers are synchronised at the listening location L1. For example, the comparison device may determine the longest time lag of the speakers, and introduce a delay into the timing of the audio playout of all the other speakers so that their audio playout is received at the listening location L1 synchronously with the audio playout from the speaker having the longest time lag. This may be implemented by the speakers being sent control signals to adjust the playout of audio signals so as to add an additional delay. Alternatively, the device which sends the speakers the audio signals to play out may adjust the speaker channels so as to introduce a delay into the timing of all the other speaker channels. In this manner, the device which sends the speakers the audio signals to play out may adjust the timing of the audio on each speaker's channel so as to cause that speaker to play out audio with the adjusted timing. Thus, subsequent audio signals played out by the speakers are received at the listening location L1 aligned in time.

The comparison device may also determine the amplitudes of the signals received from the different speakers of the speaker system. The comparison device may then compare the amplitudes of the speakers in the speaker system in order to determine whether the amplitudes are equal or not. If the amplitudes are not equal, then the comparison device determines to modify the volume levels of the speakers so as to equalise the amplitudes of received audio signals at the listening location L1. The speakers may then be sent control signals to adjust their volume levels as determined. Alternatively, the device which sends the speakers the audio signals to play out may adjust the speaker channels so as to adjust the amplitudes of the audio on the speaker channels in order to better equalise the amplitudes of the received audio signals at the listening location L1. In this manner, the device which sends the speakers the audio signals to play out may adjust the amplitude level of the audio on each speaker's channel so as to cause that speaker to play out audio with the adjusted volume. Thus, subsequent audio signals played out by the speakers are received at the listening location L1 aligned in amplitude.

If the speakers in the speaker system simultaneously play out their composite audio signals, then the microphone device receives the audio codes of the different speakers concurrently. In this case, the comparison device may also determine the relative phase of each correlation peak. The phases of future audio signals played out from the speakers are then determined to be adjusted so as to align the phases of the correlation peaks.

These adjustments to the parameters of the audio signals played out from the speakers of the speaker system may be continually updated as a user moves around the room if the microphone device (for example a mobile phone) is kept on the body of the user.

Embedding audio codes in audio signals as described herein may also be used to imperceptibly transmit link information over an audio system by incorporating that link information in the embedded audio codes. For example, in the speaker system described above, a user may adapt the volume on one speaker of the speaker system. That speaker may respond by embedding an audio code into the audio signal it is playing out, that audio code indicating the adapted volume. This audio code may then be received by the controller 522, which responds by transmitting a control signal to the speakers of the speaker system indicating to those speakers to adapt their volumes accordingly. In the case that the audio code comprises chirps, different properties of the chirps may be used to indicate different things. For example, the gradient of the chirp or the starting frequency of the chirp may be used to encode data.

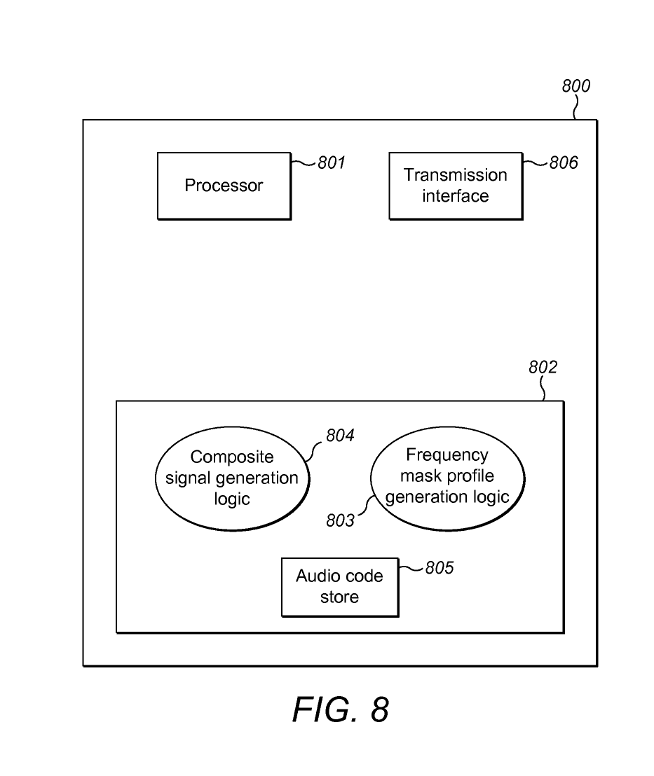

Reference is now made to FIG. 8. FIG. 8 illustrates a computing-based device 800 in which the described transmitter can be implemented. The computing-based device may be an electronic device. The computing-based device illustrates functionality used for generating and transmitting a composite audio signal as described.

Computing-based device 800 comprises a processor 801 for processing computer executable instructions configured to control the operation of the device in order to perform the data communication method. The computer executable instructions can be provided using any non-transient computer-readable media such as memory 802. Further software that can be provided at the computer-based device 800 includes frequency mask profile generation logic 803 which implements steps 201 and 202 of FIG. 2, and composite signal generation logic 804 which implements step 203 of FIG. 2. Alternatively, the controller for performing the frequency mask profile generation and the composite signal generation are implemented partially or wholly in hardware. Store 805 stores the audio code to be embedded into the audio signal. The computing-based device 800 also comprises a transmission interface 806. The transmitter includes an antenna, radio frequency (RF) front end and a baseband processor. In order to transmit signals the processor 801 can drive the RF front end, which in turn causes the antenna to emit suitable RF signals.

The applicant draws attention to the fact that the present invention may include any feature or combination of features disclosed herein either implicitly or explicitly or any generalisation thereof, without limitation to the scope of any of the present claims. In view of the foregoing description it will be evident to a person skilled in the art that various modifications may be made within the scope of the invention.

1. A method of communicating data imperceptibly in an audio signal, the method comprising:
for each sub-band of the audio signal, identifying the tone in that sub-band having the highest amplitude;
scaling an audio code comprising the data to be communicated by a frequency mask profile, the frequency mask profile having maxima at the frequencies of the identified tones;
aggregating the audio signal and the scaled audio code to form a composite audio signal; and
transmitting the composite audio signal.

2. A method as claimed in claim 1, wherein the sub-bands are frequency Barks.

3. A method as claimed in claim 1, wherein within each sub-band, the frequency mask profile decays from the maximum towards the lower frequency bound of the sub-band at a first predetermined rate, the first predetermined rate being such that the frequency mask profile is imperceptible to human hearing exposed simultaneously to the audio signal and the frequency mask profile.

4. A method as claimed in claim 3, wherein the first predetermined rate is 25 dB/Bark.

5. A method as claimed in claim 1, wherein within each sub-band, the frequency mask profile decays from the maximum towards the higher frequency bound of the sub-band at a second predetermined rate, the second predetermined rate being such that the frequency mask profile is imperceptible to human hearing exposed simultaneously to the audio signal and the frequency mask profile.

6. A method as claimed in claim 5, wherein the second predetermined rate is 10 dB/Bark.

7. A method as claimed in claim 1, the maxima of the frequency mask profile matching the amplitudes of the corresponding identified tones, the method comprising scaling the audio code by:
reducing the amplitude of the frequency mask profile by an offset to form a reduced amplitude frequency mask profile, and
multiplying the audio code by the reduced amplitude frequency mask profile.

8. A method as claimed in claim 1, the maxima of the frequency mask profile having amplitudes reduced from the corresponding identified tones by an offset, the method comprising scaling the audio code by multiplying the audio code by the amplitude frequency mask profile.

9. A method as claimed in claim 1, further comprising for a subsequent frame of the audio signal, scaling a further audio code by the frequency mask profile by:
reducing the amplitude of the frequency mask profile by a further offset to form a further reduced amplitude frequency mask profile; and
multiplying the further audio code by the further reduced amplitude frequency mask profile.

10. A method as claimed in claim 1, further comprising for a subsequent frame of the audio signal:
reducing the amplitude of the frequency mask profile by a further offset to form a further reduced amplitude frequency mask profile;
for each sub-band of the subsequent frame of the audio signal, identifying the further tone in that sub-band having the highest amplitude;
for each sub-band,
if the further identified tone has a lower amplitude than the maximum in that sub-band of the further reduced amplitude frequency mask profile, scaling a further audio code by the frequency mask profile, and
if the further identified tone has a higher amplitude than the maximum in that sub-band of the further reduced amplitude frequency mask profile, scaling the further audio code by a further frequency mask profile, the further frequency mask profile having a maximum in that sub-band at the frequency of the further identified tone.

11. A method as claimed in claim 1, further comprising embedding the audio code in each of several frames of the audio signal according to the method of claim 1.

12. A communications device for communicating data imperceptibly in an audio signal, the communications device comprising:
a processor configured to:
for each sub-band of the audio signal, identify the tone in that sub-band having the highest amplitude;
scale an audio code comprising the data to be communicated by a frequency mask profile, the frequency mask profile having maxima at the frequencies of the identified tones; and
aggregate the audio signal and the scaled audio code to form a composite audio signal; and
a transmitter configured to transmit the composite audio signal.

13. A communications device as claimed in claim 12, wherein within each sub-band, the frequency mask profile decays from the maximum towards the lower frequency bound of the sub-band at a first predetermined rate, the first predetermined rate being such that the frequency mask profile is imperceptible to human hearing exposed simultaneously to the audio signal and the frequency mask profile.

14. A communications device as claimed in claim 12, wherein within each sub-band, the frequency mask profile decays from the maximum towards the higher frequency bound of the sub-band at a second predetermined rate, the second predetermined rate being such that the frequency mask profile is imperceptible to human hearing exposed simultaneously to the audio signal and the frequency mask profile.

15. A communications device as claimed in claim 12, configured to, if the maxima of the frequency mask profile match the amplitudes of the corresponding identified tones, scale the audio code by:
reducing the amplitude of the frequency mask profile by an offset to form a reduced amplitude frequency mask profile, and
multiplying the audio code by the reduced amplitude frequency mask profile.

16. A communications device as claimed in claim 12, configured to, if the maxima of the frequency mask profile have amplitudes reduced from the corresponding identified tones by an offset, scale the audio code by multiplying the audio code by the amplitude frequency mask profile.

17. A communications device as claimed in claim 12, further configured to, for a subsequent frame of the audio signal, scale a further audio code by the frequency mask profile by:
reducing the amplitude of the frequency mask profile by a further offset to form a further reduced amplitude frequency mask profile, and
multiplying the further audio code by the further reduced amplitude frequency mask profile.

18. A communications device as claimed in claim 12, further configured to, for a subsequent frame of the audio signal:
for each sub-band of the subsequent frame of the audio signal, identify the further tone in that sub-band having the highest amplitude;
for each sub-band,
if the further identified tone has a lower amplitude than the identified tone, scale a further audio code by the frequency mask profile, and
if the further identified tone has a higher amplitude than the identified tone, scale the further audio code by a further frequency mask profile, the further frequency mask profile having a maximum in that sub-band at the frequency of the further identified tone.

19. A communications device as claimed in claim 12, further configured to embed the audio code in each of several frames of the audio signal.
